(19) United States
(12) Patent Application Publication
(10) Pub. No.: US 2026/0358510 A1
(43) Pub. Date: Nov. 12, 2026

(54) PASSIVE BISTATIC RANGING USING NULLFORMING

(71) Applicant: BAE SYSTEMS Information and Electronic Systems Integration Inc., Nashua, NH (US)

(72) Inventor: Michael H. Stockmaster, Edgemont, SD (US)

(73) Assignee: BAE SYSTEMS Information and Electronic Systems Integration Inc., Nashua, NH (US)

(21) Appl. No.: 19/199,656

(22) Filed: May 6, 2025

(51) Int. Cl. G01S 19/39; G01S 13/00; G01S 19/11

(52) U.S. Cl. CPC G01S 19/396; G01S 13/003; G01S 19/11

(57) ABSTRACT

Passive bistatic ranging. An example method includes generating a first pseudorange measurement of a direct signal, wherein the direct signal is a signal received, via an antenna, along a direct path from a source of the signal. The method also includes generating a second pseudorange measurement of a reflected signal, wherein the reflected signal is the signal received, via the antenna, from the source of the signal along a reflected path from a target. The method further includes steering a null of the antenna over a range of scan angles; determining an angle to the target based on a selected scan angle of the range of scan angles, the selected scan angle associated with a detected attenuation of a signal to noise ratio of the reflected signal; and calculating a range to the target based on the angle to the target, the first pseudorange measurement, and the second pseudorange measurement.

### FIELD OF DISCLOSURE

The present disclosure relates to passive ranging, and more particularly to nullforming based passive bistatic ranging.

### BACKGROUND

Situational awareness is important in military applications. Situational awareness includes knowledge of the relative location of other entities and targets throughout the environment, whether friendly or hostile. One method to obtain this information is through active transmission in which a radar signal is transmitted in a scan pattern around the ownship platform so that reflections may be received from targets of interest. The reflections can provide range and direction to those targets. The transmitted signal, however, can be detected by others and used to locate and identify the ownship platform, increasing risk to the platform.

### BRIEF DESCRIPTION OF THE DRAWINGS

FIG. 1 illustrates a passive bistatic ranging application, in accordance with certain embodiments of the present disclosure.

FIG. 2 illustrates geometric relationships in the ranging application of FIG. 1, in accordance with certain embodiments of the present disclosure.

FIG. 3 is a block diagram of the bistatic ranging system of FIG. 1, configured in accordance with certain embodiments of the present disclosure.

FIG. 4 illustrates signal to noise ratio (SNR) versus scan angle for the reflected path signal, in accordance with certain embodiments of the present disclosure.

FIG. 5 is a block diagram of the target angle calculator of the bistatic ranging system of FIG. 3, configured in accordance with certain embodiments of the present disclosure.

FIG. 6 is a block diagram of the target range calculator of the bistatic ranging system of FIG. 3, configured in accordance with certain embodiments of the present disclosure.

FIG. 7 is a block diagram of the target position calculator of the bistatic ranging system of FIG. 3, configured in accordance with certain embodiments of the present disclosure.

FIG. 8 is a flowchart illustrating a methodology for passive bistatic ranging, in accordance with an embodiment of the present disclosure.

FIG. 9 is a block diagram of a processing platform configured to perform passive bistatic ranging, in accordance with an embodiment of the present disclosure.

Although the following Detailed Description will proceed with reference being made to illustrative embodiments, many alternatives, modifications, and variations thereof will be apparent in light of this disclosure.

### DETAILED DESCRIPTION

Techniques are provided herein for passive bistatic ranging using nullforming. As noted above, situational awareness is important in military and other tactical applications and includes knowledge of the relative location of other objects and targets of interest throughout the environment, whether friendly or hostile. Targets of interest may include, for instance, trucks, tanks, other vehicles, buildings, other structures, personnel, and the like. Active transmission methods may be used to obtain this information, but these methods expose the ownship platform to detection by other actors.

To this end, and in accordance with an embodiment of the present disclosure, a system is provided to perform passive bistatic ranging, in which active signal transmission is not required by the system or the platform hosting the system. The employed bistatic ranging techniques are based on reception of a signal originating from other sources and travelling along both a direct path from the source and along a reflected path from one or more targets of interest. In some embodiments, the signal transmission source is a global navigation satellite system (GNSS) constellation satellite, a global positioning system (GPS) satellite, or a pseudolite transmitter (e.g., a pseudo-satellite transmitter that mimics the functionality of a navigational satellite such as a GNSS). In some embodiments, the signal transmission source may be any GNSS platform such as GPS, GLONASS, Galileo, Indian Regional Navigation Satellite System (IRNSS), Quasi-Zenith Satellite System (QZSS), and BeiDou. In some embodiments, the signal transmission source may be any governmental or commercial platform including, for example, communication satellites (including satellites that support internet communications) such as Iridium, Starlink, Kuiper, and Xona Pulsar. Additionally, nullforming is used to obtain more accurate directional estimates to the target for use in the bistatic ranging process. The nullforming capability may be provided, for instance, by an antenna array and anti-jamming receiver deployed on the host platform.

In accordance with an embodiment, a system implementing the techniques for passive bistatic ranging includes a first navigation processor configured to generate a first pseudorange measurement of a direct signal, wherein the direct signal is a signal received, via an antenna, along a direct path from a source of the signal. The system also includes a second navigation processor configured to generate a second pseudorange measurement of a reflected signal, wherein the reflected signal is the signal received, via the antenna, from the source of the signal along a reflected path from a target. The system further includes a beamformer/nullformer circuit configured to steer a null of the antenna over a range of scan angles; a target angle calculator configured to determine an angle to the target based on a selected scan angle of the range of scan angles, the selected scan angle associated with a detected attenuation of a signal to noise ratio of the reflected signal; and a target range calculator configured to calculate a range to the target based on the angle to the target, the first pseudorange measurement, and the second pseudorange measurement. The various components and circuits may be integrated differently but still provide similar functionality. For instance, in another example, the first and second navigation processors may be included in a single multicore processor, and each of the beamformer/nullformer circuit, target angle calculator, and target range calculator can be implemented in a single circuit.

It will be appreciated that the techniques described herein may provide bistatic target ranging with improved accuracy due to the higher angular resolution associated with nullforming, compared to beamforming, particularly when using smaller antennas. Additionally, the described passive techniques may provide for increased security and stealth operation compared to active ranging techniques. Numerous embodiments and applications will be apparent in light of this disclosure.

### System Architecture

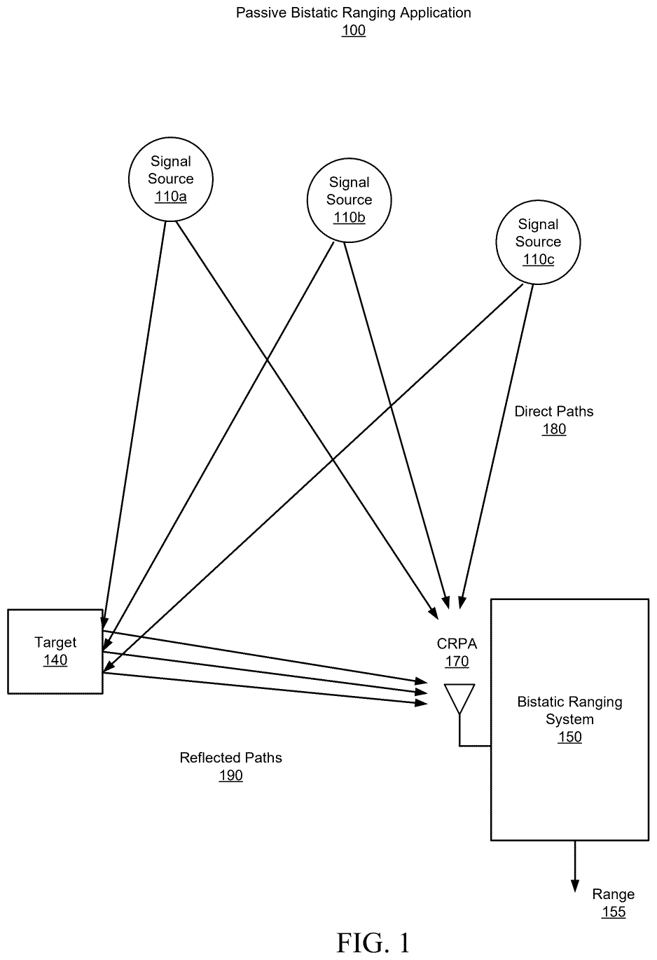

FIG. 1 illustrates a passive bistatic ranging application 100, in accordance with certain embodiments of the present disclosure. In this scenario, a number of signal transmission sources 110a, 110b, and 110c are shown. In some embodiments, the signal transmission sources may be platforms configured to provide navigation information (e.g., navigation signals). In some embodiments, a signal transmission source is a global navigation satellite system (GNSS) constellation satellite, a global positioning system (GPS) satellite, or a pseudolite transmitter (e.g., a pseudo-satellite transmitter that mimics the functionality of a navigational satellite such as a GNSS). In some embodiments, the signal transmission source may be a governmental or commercial communication satellite that transmits a signal of opportunity, including, for example, Iridium, Starlink, Kuiper, and Xona Pulsar.

A target of interest 140 is also shown along with the bistatic ranging system 150, which includes antenna 170. In some embodiments, the second antenna 170 is a controlled reception pattern antenna (CRPA) comprising an array of antenna elements that can be used to effectively steer beams and nulls in one or more desired directions. CRPAs are adaptive beam steering antennas that adjust reception patterns for incoming signals and are typically used in navigation systems to steer beams towards satellites signals and nulls towards interference or jamming signals.

Signals from the transmission sources 110 may travel along direct paths 180 to the bistatic ranging system 150, to be received by CRPA 170. The signals may also be reflected off of the target 140 and travel along reflected paths 190 to the bistatic ranging system 150, to be received by CRPA 170.

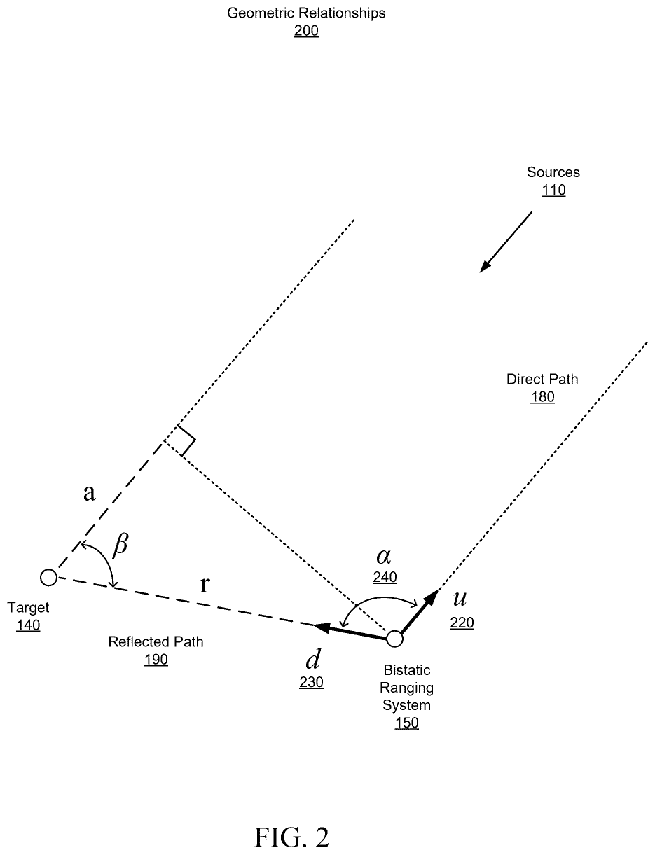

Operation of the bistatic ranging system 150 will be described in greater detail below, but at a high level, the bistatic ranging system 150 is configured to estimate an angle to the target 140 by steering a null of the CRPA 170 over a range of scan angles and searching for an attenuation of the reflected signal as the null sweeps over the target. The bistatic ranging system 150 is also configured to obtain a pseudorange measurement of the direct and reflected signals. The pseudorange is an apparent distance between the signal source and the system that is based on the time of travel of the signal along either the direct path or the reflected path. Navigation receivers typically provide a pseudorange measurement function as part of their operation, however any suitable technique may be used to obtain the pseudorange measurement, including, for example correlation or doppler-based techniques. The range to the target may then be calculated based on the estimated target angle and the pseudoranges associated with the direct and reflected paths, using a bistatic range equation as described below in connection with FIG. 2. In some embodiments, bistatic range measurements obtained in this manner may be accumulated over a period of time and used to form a synthetic aperture radar image of the target, for example as the system or the signal sources move.

FIG. 2 illustrates geometric relationships 200 in the ranging application of FIG. 1, in accordance with certain embodiments of the present disclosure. A signal of opportunity arriving from one of the signal sources 110 is shown to follow a direct path 180 and a reflected path 190 to arrive at the bistatic ranging system 150. The reflected path signal travels an additional distance of a+r compared to the direct path. The range 155 to the target, r, is the value of interest and can be determined using a bistatic range calculation based on the angle α 240. The angle α can be determined from two unit vectors u 220 and d 230. Unit vector u is the direction from the observation point (the system 150) to the source 110. Unit vector d is the direction from the observation point to the target 140. The angle α can be obtained from the vector dot product of vectors u and d by solving the following equation for α:

cos α=u·d (1)

Once the angle α is obtained from Equation (1), the angle δ can be found from Equation (2) as:

β=90−(α−90)=180−α (2)

The relation between the distances a and r is given by Equation (3):

a=r cos β=−r cos α (3)

The range r can be obtained from Equations (4) and (5):

a+r=r(1−cos α) (4)

Equation (4) can be rewritten as Equation (5) to give the range (r) 155 to the target:

$$r = \frac{a + r}{1 - cos α} \qquad ( 5 )$$

From equation (5), it is seen that the range to the target can be calculated if the angle α to the target can be estimated, where a+r is the difference between the direct path pseudo range and the reflected path pseudorange.

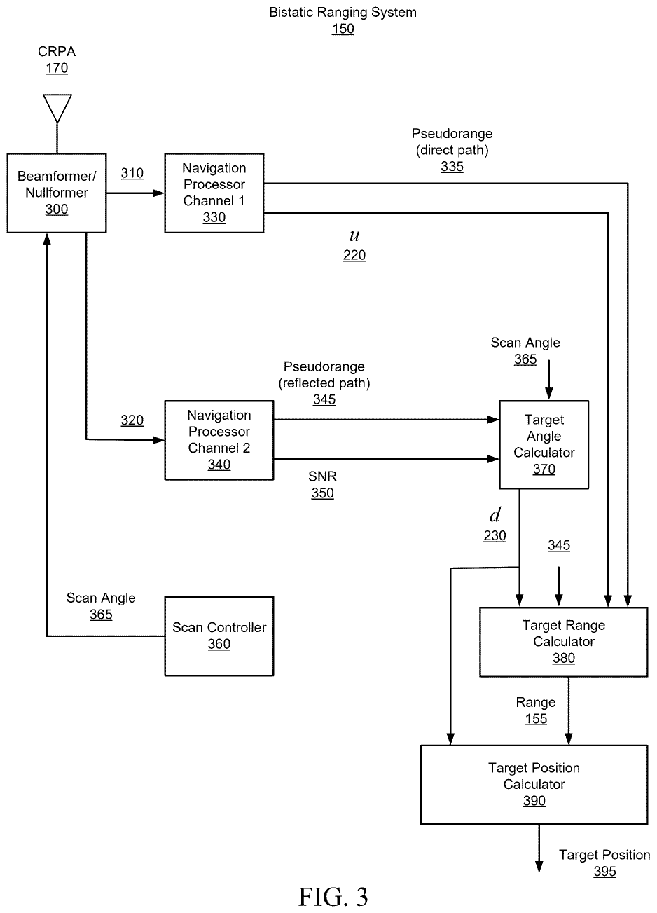

FIG. 3 is a block diagram of the bistatic ranging system 150 of FIG. 1, configured in accordance with certain embodiments of the present disclosure. The bistatic ranging system 150 is shown to include a beamformer/nullformer 300, a first navigation processor channel 330, a second navigation processor channel 340, a scan controller 360, a target angle calculator 370, a target range calculator 380, and a target position calculator 390.

The beamformer/nullformer 300 is configured to effectively steer a beam of the CRPA antenna in a direction towards one of the signal sources 110. The signal received through the beam 310 is provided to the first navigation processor channel 330.

The beamformer/nullformer 300 is also configured to steer a null of the CRPA antenna over a range of scan angles 365 (e.g., under direction of the scan controller 360). In some embodiments, the range of scan angles may cover a region of interest in which the target 140 is be expected to reside. Because the width of a steered null is generally narrower than the width of a steered beam, the null can be used to provide increased directional accuracy based on observation of attenuation of the reflected signal as the null sweeps by the target. The signal received through the null 320 is provided to the second navigation processor channel 340.

In some embodiments, the beamformer/nullformer circuit 300 is also configured to steer a beam in the direction of the target 140 (e.g., after that direction has been estimated using the null, as described below) to increase the gain of the reflected signal received through the CRPA antenna 170.

The beamformer/nullformer circuit 300 may employ any suitable technique to generate nulls and beams including, for example, an adaptive beamforming process or a minimum power beamforming process with quadratic constraint. In some embodiments, the beamformer/nullformer circuit 300 and the CRPA 170 are components of an existing anti-jamming system of the platform that hosts the bistatic ranging system 150.

The scan controller 350 is configured to provide scan angles 365 to direct the beamformer/nullformer circuit 300 to steer nulls in each of a plurality of directions that cover a scan region in which to search for the target.

The first navigation processor channel 330 is configured to operate on the output 310 of the beamformer/nullformer 300 (e.g., the steered beam) to generate a first pseudorange measurement 335 of the received signal along the direct path 180 from the source of the signal. The pseudorange measurement may be generated using any suitable technique as performed by a navigation processor.

The first navigation processor channel 330 is also configured to generate a direction vector u 220 from the system 150 to the source 110 of the signal. The direction vector 220 may be generated using any suitable technique as performed by a navigation processor. For example, the location of the system 150 may be known (using GNSS or GPS) and the location of the source 110 may be known (e.g., through satellite ephemeris data or by other means) allowing a direction to be calculated between these two known locations (e.g., the system 150 and the source 110).

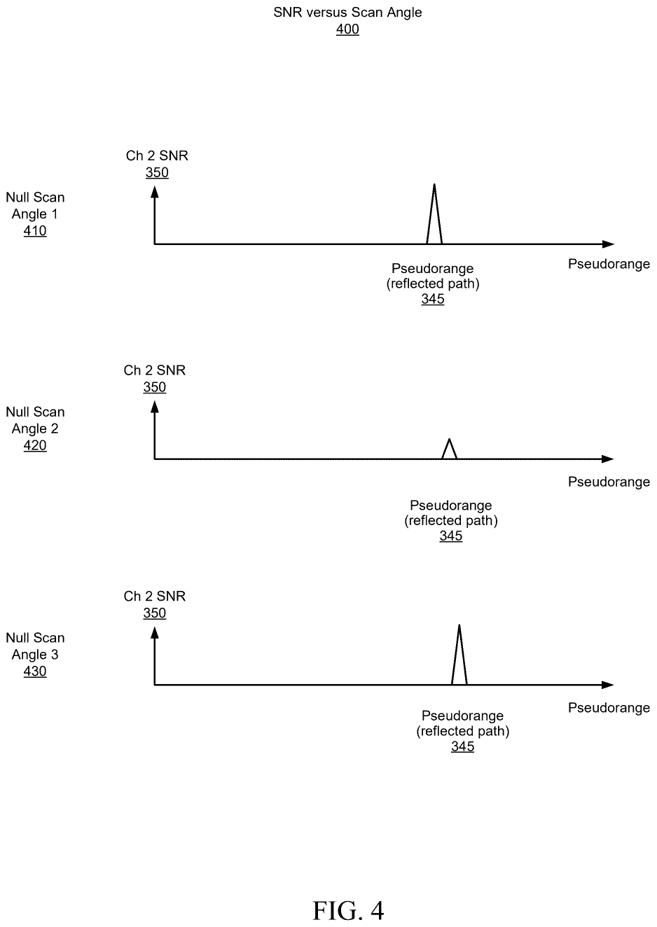

The second navigation processor channel 340 is configured to operate on the output 320 of the beamformer/nullformer 300 (e.g., the steered null) to generate a second pseudorange measurement 345 of the received signal along the reflected path 190 from the source of the signal. The pseudorange measurement may be generated using any suitable technique as performed by a navigation processor. The second navigation processor channel 340 is also configured to measure the signal to noise ratio (e.g., C/No) 350 of the reflected signal, using any suitable technique as performed by a navigation processor. An example of the measured SNRs 350 is illustrated in FIG. 4 for different scan angles.

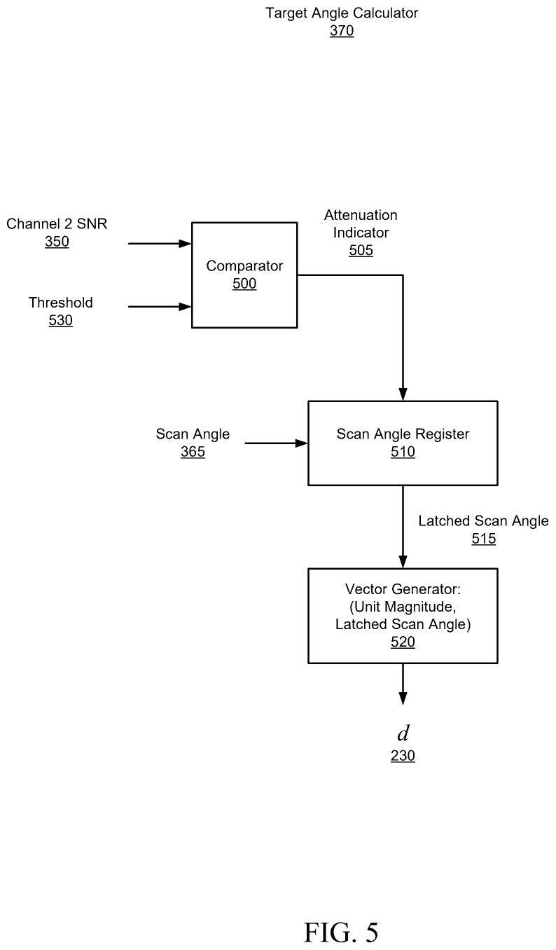

The target angle calculator 370 is configured to determine the angle to the target (unit vector d 230) as being the scan angle associated with a detected attenuation of the SNR 350 of the reflected signal, as described below in connection with FIG. 5.

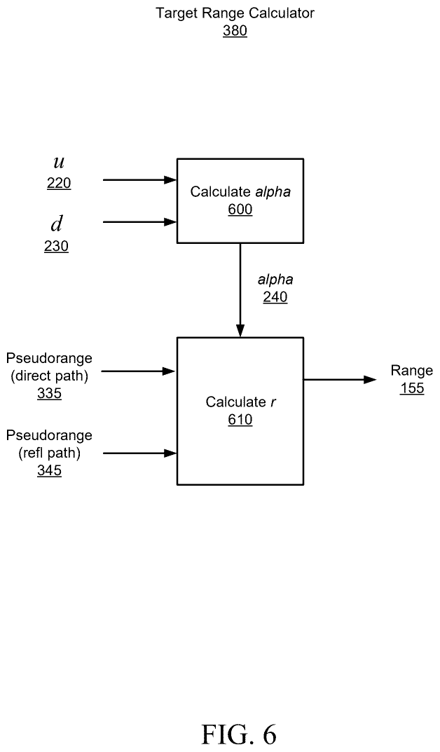

The target range calculator 380 is configured to calculate a range 155 to the target based on the angle to the target (d 230), the direct path pseudorange 335, the reflected path pseudorange 345, and the direction vector (u 220) to the source of the signal. The range 155 may be calculated using Equation (5), where a+r is the difference between the direct path pseudo range and the reflected path pseudorange, and cos α is the vector dot product of u and d, as described below in connection with FIG. 6.

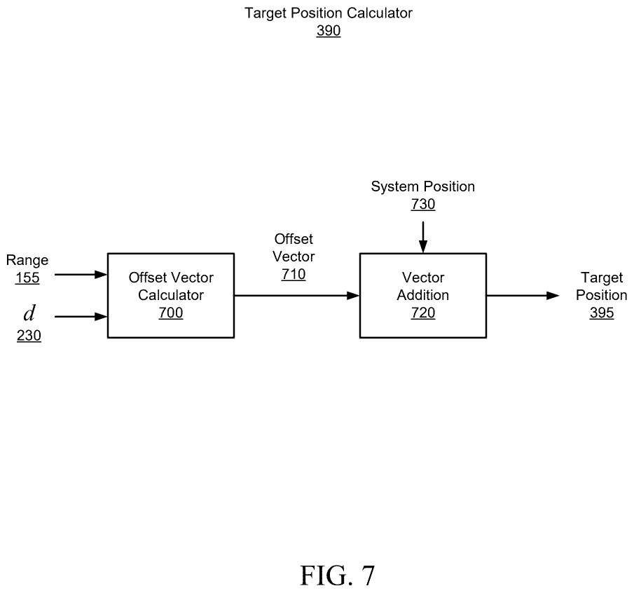

The target position calculator 390 is configured to calculate a position 395 of the target based on the calculated range 155 and the angle to the target (e.g., d vector 230), as described below in connection with FIG. 7. For example, the position 395 of the target may be calculated relative to the known position of the system 150, as an offset equal to the calculated range 155 to the target in a direction equal to the angle to the target.

FIG. 4 illustrates SNR versus scan angle 400 for the reflected path signal, in accordance with certain embodiments of the present disclosure. The SNR 350 is provided by the second navigation processor channel 340. The SNR is shown at the pseudorange 345 for the reflected signal as the null scan angle 365 is varied over a range of angles including a first angle 410 (e.g., just to one side of the target), a second angle 420 (e.g., directly on the target), and a third angle 430 (e.g., just to the opposite side of the target). In this example, as the null is steered through the second angle 420, the SNR is attenuated, while at the first and third angles, the SNR is greater because the null is steered slightly away from the target.

FIG. 5 is a block diagram of the target angle calculator 370 of the bistatic ranging system of FIG. 3, configured in accordance with certain embodiments of the present disclosure. The target angle calculator 370 is shown to include a comparator 500, a scan angle register 510 and a vector generator 520.

Comparator 500 is configured to compare the SNR 350 of the reflected signal to a threshold 530. The SNR of the reflected path signal received through the beamformer/nullformer will generally reach a minimum value when the null is steered directly to the target. When the SNR 350 falls below the threshold value 530, an indicator 505 is generated to indicate that the reflected signal has been attenuated as the null scans over the target.

The scan angle register 510 is configured to latch the scan angle 365 in response to the attenuation indicator 505 that is associated with the detected attenuation of the SNR 350. The vector generator 520 is configured to form the unit vector d 230 as a vector having a unit magnitude and an angle equal to the latched scan angle 515.

FIG. 6 is a block diagram of the target range calculator 380 of the bistatic ranging system 150 of FIG. 3, configured in accordance with certain embodiments of the present disclosure. Target range calculator 380 is shown to include an alpha calculator 600 and a range calculator 610. The alpha calculator 600 is configured to calculate the angle alpha 240 based on the unit vectors u 220 and d 230, for example as specified by equation (1) above. The range calculator 610 is configured to calculate the range 155 based on alpha 240, the direct path pseudorange 335, and the reflected path pseudorange 345, for example as specified by equation (5) above.

FIG. 7 is a block diagram of the target position calculator 390 of the bistatic ranging system 150 of FIG. 3, configured in accordance with certain embodiments of the present disclosure. The target position calculator 390 is configured to calculate the position 395 of the target as a relative offset from the position 730 of the system 150. The relative offset is at a range 155 in a direction specified by the d vector 230. The system position 730 may be determined using any suitable techniques. For example, in the case of a fixed platform, the position may be determined based on a geographic survey. For a mobile platform, the position may be obtained from a GNSS or GPS processor based on navigation information received from multiple satellites or pseudolites. Target position calculator 390 is shown to include offset vector calculator 700 and vector addition circuit 720. The offset vector calculator 700 is configured to calculate an offset vector 710 having a magnitude equal to the range 155 and an angle equal to the angle of the unit vector d 230. The vector addition circuit is configured to add the offset vector 710 to the system position 730 to generate the target position 395.

### Methodology

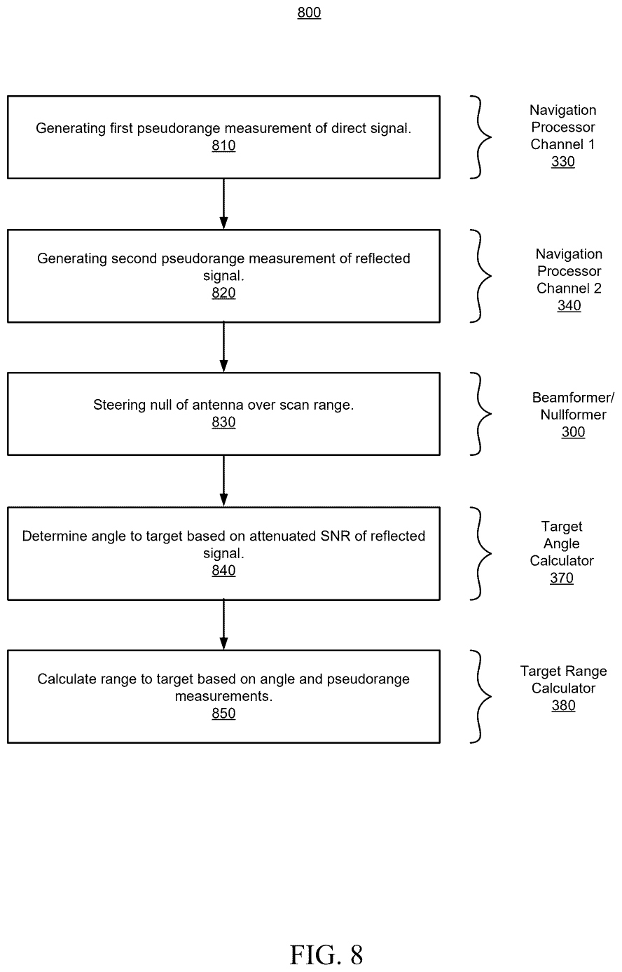

FIG. 8 is a flowchart illustrating a methodology 800 for passive bistatic ranging, in accordance with an embodiment of the present disclosure. As can be seen, example method 800 includes a number of phases and sub-processes, the sequence of which may vary from one embodiment to another. However, when considered in aggregate, these phases and sub-processes form a process passive bistatic ranging, in accordance with certain of the embodiments disclosed herein, for example as illustrated in FIGS. 1-7, as described above. However other system architectures can be used in other embodiments, as will be apparent in light of this disclosure. To this end, the correlation of the various functions shown in FIG. 8 to the specific components illustrated in the figures, is not intended to imply any structural and/or use limitations. Rather other embodiments may include, for example, varying degrees of integration wherein multiple functionalities are effectively performed by one system. Numerous variations and alternative configurations will be apparent in light of this disclosure.

In one embodiment, method 800 commences, at operation 810, by generating a first pseudorange measurement of a direct signal, wherein the direct signal is a signal received, via an antenna, along a direct path from a source of the signal. In some embodiments, the pseudorange measurement as provided by any suitable techniques as performed by a navigation processor.

At operation 820, a second pseudorange measurement is generated of a reflected signal, wherein the reflected signal is the signal received, via the antenna, from the source of the signal along a reflected path from a target. In some embodiments, the second pseudorange measurement is also provided by any suitable techniques as performed by a navigation processor.

At operation 830, a null of the antenna is steered over a range of scan angles.

At operation 840, an angle to the target is determined based on a selected scan angle of the range of scan angles. The selected scan angle is associated with a detected attenuation of a signal to noise ratio of the reflected signal.

At operation 850, a range to the target is calculated based on the angle to the target, the first pseudorange measurement, and the second pseudorange measurement.

In some embodiments, additional operations may be performed, as previously described in connection with the system. For example, a direction vector to the source of the signal is generated and the target range calculation is further based on that direction vector. In some embodiments, a beam is steered in the selected scan angle to increase gain of the signal, received through the antenna, along the reflected path from the target. In some embodiments, a position of the target is calculated based on the calculated range and the angle to the target.

### Example System

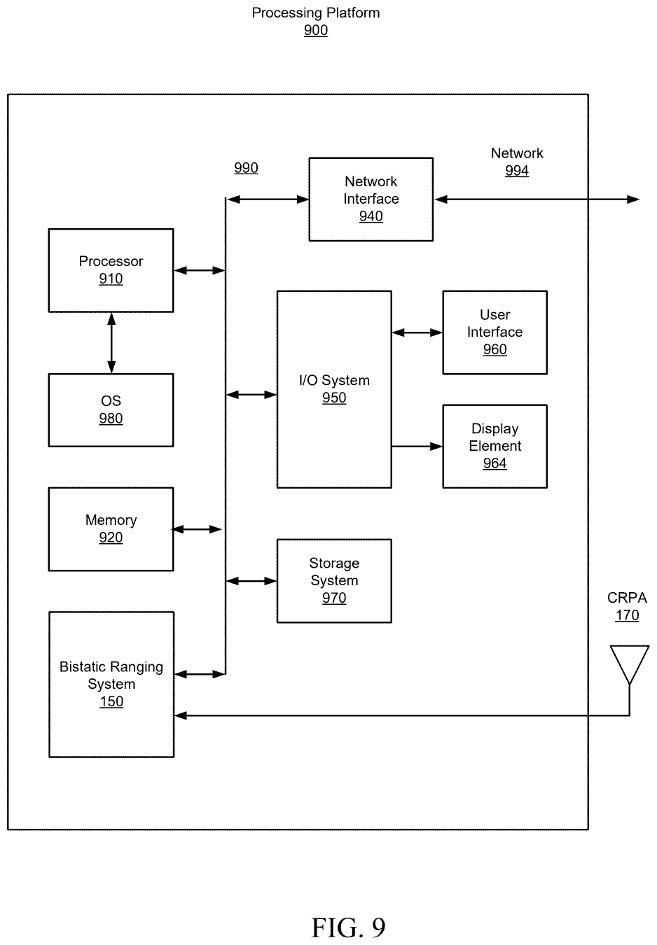

FIG. 9 is a block diagram of a processing platform 900 configured to passive bistatic ranging, in accordance with an embodiment of the present disclosure. In some embodiments, platform 900, or portions thereof, may be hosted on, or otherwise be incorporated into the electronic systems of an aircraft, ship, ground station, or man-portable system deployment.

In some embodiments, platform 900 may comprise any combination of a processor 910, memory 920, a network interface 940, an input/output (I/O) system 950, a user interface 960, a display element 964, a storage system 970, bistatic ranging system 150, and antenna 170. As can be further seen, a bus and/or interconnect 990 is also provided to allow for communication between the various components listed above and/or other components not shown. Platform 900 can be coupled to a network 994 through network interface 940 to allow for communications with other computing devices, platforms, devices to be controlled, or other resources. Other componentry and functionality not reflected in the block diagram of FIG. 9 will be apparent in light of this disclosure, and it will be appreciated that other embodiments are not limited to any particular hardware configuration.

Processor 910 can be any suitable processor, and may include one or more coprocessors or controllers, such as an audio processor, a graphics processing unit, or hardware accelerator, to assist in the execution of mission software and/or any control and processing operations associated with platform 900, including operation of the bistatic ranging system 150. In some embodiments, the processor 910 may be implemented as any number of processor cores. The processor (or processor cores) may be any type of processor, such as, for example, a micro-processor, an embedded processor, a digital signal processor (DSP), a graphics processor (GPU), a tensor processing unit (TPU), a network processor, a field programmable gate array or other device configured to execute code. The processors may be multithreaded cores in that they may include more than one hardware thread context (or “logical processor”) per core. Processor 910 may be implemented as a complex instruction set computer (CISC) or a reduced instruction set computer (RISC) processor. In some embodiments, processor 910 may be configured as an x86 instruction set compatible processor.

Memory 920 can be implemented using any suitable type of digital storage including, for example, flash memory and/or random access memory (RAM). In some embodiments, the memory 920 may include various layers of memory hierarchy and/or memory caches as are known to those of skill in the art. Memory 920 may be implemented as a volatile memory device such as, but not limited to, a RAM, dynamic RAM (DRAM), or static RAM (SRAM) device. Storage system 970 may be implemented as a non-volatile storage device such as, but not limited to, one or more of a hard disk drive (HDD), a solid-state drive (SSD), a universal serial bus (USB) drive, an optical disk drive, tape drive, an internal storage device, an attached storage device, flash memory, battery backed-up synchronous DRAM (SDRAM), and/or a network accessible storage device.

Processor 910 may be configured to execute an Operating System (OS) 980 which may comprise any suitable operating system, such as Google Android (Google Inc., Mountain View, CA), Microsoft Windows (Microsoft Corp., Redmond, WA), Apple OS X (Apple Inc., Cupertino, CA), Linux, or a real-time operating system (RTOS). As will be appreciated in light of this disclosure, the techniques provided herein can be implemented without regard to the particular operating system provided in conjunction with platform 900 and therefore may also be implemented using any suitable existing or subsequently-developed platform.

Network interface circuit 940 can be any appropriate network chip or chipset which allows for wired and/or wireless connection between other components of platform 900 and/or network 994, thereby enabling platform 900 to communicate with other local and/or remote computing systems, and/or other resources. Wired communication may conform to existing (or yet to be developed) standards, such as, for example, Ethernet. Wireless communication may conform to existing (or yet to be developed) standards, such as, for example, cellular communications including LTE (Long Term Evolution) and 5G, Wireless Fidelity (Wi-Fi), Bluetooth, and/or Near Field Communication (NFC). Exemplary wireless networks include, but are not limited to, wireless local area networks, wireless personal area networks, wireless metropolitan area networks, cellular networks, and satellite networks.

I/O system 950 may be configured to interface between various I/O devices and other components of platform 900. I/O devices may include, but not be limited to, user interface 960 and display element 964. User interface 960 may include devices (not shown) such as a touchpad, display unit, keyboard, and mouse, etc., for example, to allow the user to control the system. Display element 964 may be configured to display information to a user. I/O system 950 may include a graphics subsystem configured to perform processing of images for rendering on the display element 964. Graphics subsystem may be a graphics processing unit (GPU) or a visual processing unit (VPU), for example. An analog or digital interface may be used to communicatively couple graphics subsystem and the display element. For example, the interface may be any of a high definition multimedia interface (HDMI), DisplayPort, wireless HDMI, and/or any other suitable interface using wireless high definition compliant techniques. In some embodiments, the graphics subsystem could be integrated into processor 910 or any chipset of platform 900.

It will be appreciated that in some embodiments, the various components of platform 900 may be combined or integrated in a system-on-a-chip (SoC) architecture. In some embodiments, the components may be hardware components, firmware components, software components or any suitable combination of hardware, firmware, or software.

Bistatic ranging system 150 is configured to estimate the range to a target using passive techniques based on processing of direct path and reflected path signals, as described previously. Bistatic ranging system 150 may include any or all of the circuits/components illustrated in FIGS. 3 and 5-7, as described above. These components can be implemented or otherwise used in conjunction with a variety of suitable software and/or hardware that is coupled to or that otherwise forms a part of platform 900. These components can additionally or alternatively be implemented or otherwise used in conjunction with user I/O devices that are capable of providing information to, and receiving information and commands from, a user.

In various embodiments, platform 900 may be implemented as a wireless system, a wired system, or a combination of both. When implemented as a wireless system, platform 900 may include components and interfaces suitable for communicating over a wireless shared media, such as one or more antennae, transmitters, receivers, transceivers, amplifiers, filters, control logic, and so forth. An example of wireless shared media may include portions of a wireless spectrum, such as the radio frequency spectrum and so forth. When implemented as a wired system, platform 900 may include components and interfaces suitable for communicating over wired communications media, such as input/output adapters, physical connectors to connect the input/output adaptor with a corresponding wired communications medium, a network interface card (NIC), disc controller, video controller, audio controller, and so forth. Examples of wired communications media may include a wire, cable metal leads, printed circuit board (PCB), backplane, switch fabric, semiconductor material, twisted pair wire, coaxial cable, fiber optics, and so forth.

Various embodiments may be implemented using hardware elements, software elements, or a combination of both. Examples of hardware elements may include processors, microprocessors, circuits, circuit elements (for example, transistors, resistors, capacitors, inductors, and so forth), integrated circuits, ASICs, programmable logic devices, digital signal processors, FPGAs, logic gates, registers, semiconductor devices, chips, microchips, chipsets, and so forth. Programmable logic devices, FPGAs, logic gates, and gate level logic may be referred to herein as “logic.” Examples of software may include software components, programs, applications, computer programs, application programs, system programs, machine programs, operating system software, middleware, firmware, software modules, routines, subroutines, functions, methods, procedures, software interfaces, application program interfaces, instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power level, heat tolerances, processing cycle budget, input data rates, output data rates, memory resources, data bus speeds, and other design or performance constraints.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still cooperate or interact with each other.

The various embodiments disclosed herein can be implemented in various forms of hardware, software, firmware, and/or special purpose processors. For example, in one embodiment at least one non-transitory computer readable storage medium has instructions encoded thereon that, when executed by one or more processors, cause one or more of the methodologies disclosed herein to be implemented. The instructions can be encoded using a suitable programming language, such as C, C++, object oriented C, Java, JavaScript, Visual Basic. NET, Beginner's All-Purpose Symbolic Instruction Code (BASIC), or alternatively, using custom or proprietary instruction sets. The instructions can be provided in the form of one or more computer software applications and/or applets that are tangibly embodied on a memory device, and that can be executed by a computer having any suitable architecture. In one embodiment, the system can be hosted on a given website and implemented, for example, using JavaScript or another suitable browser-based technology. For instance, in certain embodiments, the system may leverage processing resources provided by a remote computer system accessible via network 994. The computer software applications disclosed herein may include any number of different modules, sub-modules, or other components of distinct functionality, and can provide information to, or receive information from, still other components. These modules can be used, for example, to communicate with input and/or output devices such as a display screen, a touch sensitive surface, a printer, and/or any other suitable device. Other componentry and functionality not reflected in the illustrations will be apparent in light of this disclosure, and it will be appreciated that other embodiments are not limited to any particular hardware or software configuration. Thus, in other embodiments platform 900 may comprise additional, fewer, or alternative subcomponents as compared to those included in the example embodiment of FIG. 9.

The aforementioned non-transitory computer readable medium may be any suitable medium for storing digital information, such as a hard drive, a server, a flash memory, and/or random-access memory (RAM), or a combination of memories. In alternative embodiments, the components and/or modules disclosed herein can be implemented with hardware, including gate level logic such as a field-programmable gate array (FPGA), or alternatively, a purpose-built semiconductor such as an application-specific integrated circuit (ASIC). As such, in some embodiments, software may be implemented as logic. Still other embodiments may be implemented with a microcontroller having a number of input/output ports for receiving and outputting data, and a number of embedded routines for carrying out the various functionalities disclosed herein. It will be apparent that any suitable combination of hardware, software, and firmware can be used, and that other embodiments are not limited to any particular system architecture.

Some embodiments may be implemented, for example, using a machine readable medium or article which may store an instruction or a set of instructions that, if executed by a machine, may cause the machine to perform a method, process, and/or operations in accordance with the embodiments. Such a machine may include, for example, any suitable processing platform, computing platform, computing device, processing device, computing system, processing system, computer, process, or the like, and may be implemented using any suitable combination of hardware and/or software. The machine readable medium or article may include, for example, any suitable type of memory unit, memory device, memory article, memory medium, storage device, storage article, storage medium, and/or storage unit, such as memory, removable or non-removable media, erasable or non-erasable media, writeable or rewriteable media, digital or analog media, hard disk, floppy disk, compact disk read only memory (CD-ROM), compact disk recordable (CD-R) memory, compact disk rewriteable (CD-RW) memory, optical disk, magnetic media, magneto-optical media, removable memory cards or disks, various types of digital versatile disk (DVD), a tape, a cassette, or the like. The instructions may include any suitable type of code, such as source code, compiled code, interpreted code, executable code, static code, dynamic code, encrypted code, and the like, implemented using any suitable high level, low level, object oriented, visual, compiled, and/or interpreted programming language.

Unless specifically stated otherwise, it may be appreciated that terms such as “processing,” “computing,” “calculating,” “determining,” or the like refer to the action and/or process of a computer or computing system, or similar electronic computing device, that manipulates and/or transforms data represented as physical quantities (for example, electronic) within the registers and/or memory units of the computer system into other data similarly represented as physical entities within the registers, memory units, or other such information storage transmission or displays of the computer system. The embodiments are not limited in this context.

The terms “circuit” or “circuitry,” as used in any embodiment herein, are functional and may comprise, for example, singly or in any combination, hardwired circuitry, programmable circuitry such as computer processors comprising one or more individual instruction processing cores, state machine circuitry, and/or firmware that stores instructions executed by programmable circuitry. The circuitry may include a processor and/or controller configured to execute one or more instructions to perform one or more operations described herein. The instructions may be embodied as, for example, an application, software, firmware, etc. configured to cause the circuitry to perform any of the aforementioned operations. Software may be embodied as a software package, code, instructions, instruction sets and/or data recorded on a computer-readable storage device. Software may be embodied or implemented to include any number of processes, and processes, in turn, may be embodied or implemented to include any number of threads, etc., in a hierarchical fashion. Firmware may be embodied as code, instructions or instruction sets and/or data that are hard-coded (e.g., nonvolatile) in memory devices. The circuitry may, collectively or individually, be embodied as circuitry that forms part of a larger system, for example, an integrated circuit (IC), an application-specific integrated circuit (ASIC), a system-on-a-chip (SoC), desktop computers, laptop computers, tablet computers, servers, smartphones, etc. Other embodiments may be implemented as software executed by a programmable control device. In such cases, the terms “circuit” or “circuitry” are intended to include a combination of software and hardware such as a programmable control device or a processor capable of executing the software. As described herein, various embodiments may be implemented using hardware elements, software elements, or any combination thereof. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Numerous specific details have been set forth herein to provide a thorough understanding of the embodiments. It will be understood, however, that other embodiments may be practiced without these specific details, or otherwise with a different set of details. It will be further appreciated that the specific structural and functional details disclosed herein are representative of example embodiments and are not necessarily intended to limit the scope of the present disclosure. In addition, although the subject matter has been described in language specific to structural features and/or methodological acts, it is to be understood that the subject matter defined in the appended claims is not necessarily limited to the specific features or acts described herein. Rather, the specific features and acts described herein are disclosed as example forms of implementing the claims.

### FURTHER EXAMPLE EMBODIMENTS

The following examples pertain to further embodiments, from which numerous permutations and configurations will be apparent.

Example 1 is a bistatic ranging system comprising: a first navigation processor configured to generate a first pseudorange measurement of a direct signal, wherein the direct signal is a signal received, via an antenna, along a direct path from a source of the signal; a second navigation processor configured to generate a second pseudorange measurement of a reflected signal, wherein the reflected signal is the signal received, via the antenna, from the source of the signal along a reflected path from a target; a beamformer/nullformer circuit configured to steer a null of the antenna over a range of scan angles; a target angle calculator configured to determine an angle to the target based on a selected scan angle of the range of scan angles, the selected scan angle associated with a detected attenuation of a signal to noise ratio of the reflected signal; and a target range calculator configured to calculate a range to the target based on the angle to the target, the first pseudorange measurement, and the second pseudorange measurement.

Example 2 includes the system of Example 1, wherein the first navigation processor is configured to generate a direction vector to the source of the signal and the target range calculator is configured to calculate the range to the target further based on the direction vector to the source of the signal.

Example 3 includes the system of Examples 1 or 2, comprising the antenna, wherein the antenna is a controlled reception pattern antenna.

Example 4 includes the system of any of Examples 1-3, wherein the second navigation processor is configured to measure the signal to noise ratio of the reflected signal.

Example 5 includes the system of any of Examples 1-4, wherein the signal is a global navigation satellite system signal, a global positioning system satellite signal, or a pseudolite generated signal.

Example 6 includes the system of any of Examples 1-5, wherein the signal source is a communications satellite.

Example 7 includes the system of any of Examples 1-6, wherein the beamformer/nullformer circuit is configured to steer a beam in the selected scan angle to increase gain of the reflected signal.

Example 8 includes the system of any of Examples 1-7, comprising a target position calculator configured to calculate a position of the target based on the calculated range and the angle to the target.

Example 9 is a computer program product including one or more non-transitory machine-readable mediums encoded with instructions that when executed by one or more processors cause a process to be carried out for bistatic ranging, the process comprising: generating a first pseudorange measurement of a direct signal, wherein the direct signal is a signal received, via an antenna, along a direct path from a source of the signal; generating a second pseudorange measurement of a reflected signal, wherein the reflected signal is the signal received, via the antenna, from the source of the signal along a reflected path from a target; steering a null of the antenna over a range of scan angles; determining an angle to the target based on a selected scan angle of the range of scan angles, the selected scan angle associated with a detected attenuation of a signal to noise ratio of the reflected signal; and calculating a range to the target based on the angle to the target, the first pseudorange measurement, and the second pseudorange measurement.

Example 10 includes the computer program product of Example 9, wherein the process comprises generating a direction vector to the source of the signal and calculating the range to the target further based on the direction vector to the source of the signal.

Example 11 includes the computer program product of Examples 9 or 10, wherein the antenna is a controlled reception pattern antenna.

Example 12 includes the computer program product of any of Examples 9-11, wherein the signal is a global navigation satellite system signal or a global positioning system satellite signal.

Example 13 includes the computer program product of any of Examples 9-12, wherein the process comprises steering a beam in the selected scan angle to increase gain of the reflected signal.

Example 14 includes the computer program product of any of Examples 9-13, wherein the process comprises calculating a position of the target based on the calculated range and the angle to the target.

Example 15 is a method for bistatic ranging, the method comprising: generating a first pseudorange measurement of a direct signal, wherein the direct signal is a signal received, via an antenna, along a direct path from a source of the signal; generating a second pseudorange measurement of a reflected signal, wherein the reflected signal is the signal received, via the antenna, from the source of the signal along a reflected path from a target; steering a null of the antenna over a range of scan angles; determining an angle to the target based on a selected scan angle of the range of scan angles, the selected scan angle associated with a detected attenuation of a signal to noise ratio of the reflected signal; and calculating a range to the target based on the angle to the target, the first pseudorange measurement, and the second pseudorange measurement.

Example 16 includes the method of Example 15, comprising generating a direction vector to the source of the signal and calculating the range to the target further based on the direction vector to the source of the signal.

Example 17 includes the method of Examples 15 or 16, wherein the antenna is a controlled reception pattern antenna.

Example 18 includes the method of any of Examples 15-17, wherein the signal is a global navigation satellite system signal or a global positioning system satellite signal.

Example 19 includes the method of any of Examples 15-18, comprising steering a beam in the selected scan angle to increase gain of the reflected signal.

Example 20 includes the method of any of Examples 15-19, comprising calculating a position of the target based on the calculated range and the angle to the target.

Example 21 is a circuit comprising: first logic configured to generate a first correlation signal, wherein a peak of the first correlation signal indicates a time of arrival (t1) of a navigation signal, received via an antenna, along a direct path from a source of the navigation signal; second logic configured to generate a second correlation signal, wherein a peak of the second correlation signal indicates a time of arrival (t2) of the navigation signal, received via the antenna, along a reflected path from a target; third logic configured to steer a null of the antenna over a range of scan angles; fourth logic configured to detect an attenuation of the peak of the second correlation signal as the null is steered over the range of scan angles; fifth logic configured to determine an angle to the target based on a selected scan angle of the range of scan angles, the selected scan angle associated with the detected attenuation; and sixth logic configured to calculate a range to the target based on the angle to the target, the time of arrival t1, and the time of arrival t2.

Example 22 includes the circuit of Example 21, comprising: seventh logic configured to generate a direction vector to the source of the navigation signal and the sixth logic configured to calculate the range to the target further based on the direction vector to the source of the navigation signal.

Example 23 includes the circuit of Examples 21 or 22, further comprising the antenna, wherein the antenna is a controlled reception pattern antenna.

Example 24 includes the system of any of Examples 21-23, wherein the navigation signal is a global navigation satellite system signal or a global positioning system satellite signal.

Example 25 includes the system of any of Examples 21-24, wherein the third logic is configured to steer a beam in the selected scan angle to increase gain of the navigation signal, received via the antenna, along the reflected path from the target.

Example 26 includes the system of any of Examples 21-25, comprising: ninth logic configured to calculate a position of the target based on the calculated range and the angle to the target.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be appreciated in light of this disclosure. The present disclosure should, therefore, be considered to encompass such combinations, variations, and modifications. It is intended that the scope of the present disclosure be limited not by this detailed description, but rather by the claims appended hereto. Future filed applications claiming priority to this application may claim the disclosed subject matter in a different manner and may generally include any set of one or more elements as variously disclosed or otherwise demonstrated herein.

What is claimed is:

1. A bistatic ranging system comprising:
a first navigation processor configured to generate a first pseudorange measurement of a direct signal, wherein the direct signal is a signal received, via an antenna, along a direct path from a source of the signal;
a second navigation processor configured to generate a second pseudorange measurement of a reflected signal, wherein the reflected signal is the signal received, via the antenna, from the source of the signal along a reflected path from a target;
a beamformer/nullformer circuit configured to steer a null of the antenna over a range of scan angles;
a target angle calculator configured to determine an angle to the target based on a selected scan angle of the range of scan angles, the selected scan angle associated with a detected attenuation of a signal to noise ratio of the reflected signal; and
a target range calculator configured to calculate a range to the target based on the angle to the target, the first pseudorange measurement, and the second pseudorange measurement.

2. The system of claim 1, wherein the first navigation processor is configured to generate a direction vector to the source of the signal and the target range calculator is configured to calculate the range to the target further based on the direction vector to the source of the signal.

3. The system of claim 1, comprising the antenna, wherein the antenna is a controlled reception pattern antenna.

4. The system of claim 1, wherein the second navigation processor is configured to measure the signal to noise ratio of the reflected signal.

5. The system of claim 1, wherein the signal is a global navigation satellite system signal, a global positioning system satellite signal, or a pseudolite generated signal.

6. The system of claim 1, wherein the signal source is a communications satellite.

7. The system of claim 1, wherein the beamformer/nullformer circuit is configured to steer a beam in the selected scan angle to increase gain of the reflected signal.

8. The system of claim 1, comprising a target position calculator configured to calculate a position of the target based on the calculated range and the angle to the target.

9. A computer program product including one or more non-transitory machine-readable mediums encoded with instructions that when executed by one or more processors cause a process to be carried out for bistatic ranging, the process comprising:
generating a first pseudorange measurement of a direct signal, wherein the direct signal is a signal received, via an antenna, along a direct path from a source of the signal;
generating a second pseudorange measurement of a reflected signal, wherein the reflected signal is the signal received, via the antenna, from the source of the signal along a reflected path from a target;
steering a null of the antenna over a range of scan angles;
determining an angle to the target based on a selected scan angle of the range of scan angles, the selected scan angle associated with a detected attenuation of a signal to noise ratio of the reflected signal; and
calculating a range to the target based on the angle to the target, the first pseudorange measurement, and the second pseudorange measurement.

10. The computer program product of claim 9, wherein the process comprises generating a direction vector to the source of the signal and calculating the range to the target further based on the direction vector to the source of the signal.

11. The computer program product of claim 9, wherein the antenna is a controlled reception pattern antenna.

12. The computer program product of claim 9, wherein the signal is a global navigation satellite system signal or a global positioning system satellite signal.

13. The computer program product of claim 9, wherein the process comprises steering a beam in the selected scan angle to increase gain of the reflected signal.

14. The computer program product of claim 9, wherein the process comprises calculating a position of the target based on the calculated range and the angle to the target.

15. A method for bistatic ranging, the method comprising:
generating a first pseudorange measurement of a direct signal, wherein the direct signal is a signal received, via an antenna, along a direct path from a source of the signal;
generating a second pseudorange measurement of a reflected signal, wherein the reflected signal is the signal received, via the antenna, from the source of the signal along a reflected path from a target;
steering a null of the antenna over a range of scan angles;
determining an angle to the target based on a selected scan angle of the range of scan angles, the selected scan angle associated with a detected attenuation of a signal to noise ratio of the reflected signal; and
calculating a range to the target based on the angle to the target, the first pseudorange measurement, and the second pseudorange measurement.

16. The method of claim 15, comprising generating a direction vector to the source of the signal and calculating the range to the target further based on the direction vector to the source of the signal.

17. The method of claim 15, wherein the antenna is a controlled reception pattern antenna.

18. The method of claim 15, wherein the signal is a global navigation satellite system signal or a global positioning system satellite signal.

19. The method of claim 15, comprising steering a beam in the selected scan angle to increase gain of the reflected signal.

20. The method of claim 15, comprising calculating a position of the target based on the calculated range and the angle to the target.
